(19) United States
(12) Patent Application Publication
(10) Pub. No.: US 2006/0183576 A1
(43) Pub. Date: Aug. 17, 2006

(54) Throwable object featuring message record and impact-activated playback

(76) Inventors: Michael K. Lindsey, Barrington, IL (US); Stephen J. Pearson, Ingleside, IL (US)

Correspondence Address: MICHAEL K. LINDSEY;GAVRILOVICH, DODD & LINDSEY, LLP, 3303 N. SHOWDOWN PL., TUCSON, AZ, 85749, US

(21) Appl. No.: 11/058,953

(22) Filed: Feb. 16, 2005

(51) Int. Cl. H04M 1/64

(52) U.S. Cl. 473/570

(57) ABSTRACT

An electronic recording device that has an impact-activated playback function and a body adapted to allow the device sustained repeated physical impacts without damage to its internal components. In operation, a user records a message and then puts the device in motion by, for example, throwing or dropping it. The device plays back the message automatically upon impacting something. The message can any suitable type of recordable content, including audio content such a voice, music, noise, or any other sound and/or visual content, such as graphics, images, video or the like.

### TECHNICAL FIELD

The present invention relates generally to devices that are capable of recording and playing back messages, and in particular, to a throwable recording device that has an impact-activated playback function.

### BACKGROUND

No other species has a repertoire that matches humanity's capacity to communicate. Over the course of history, people have developed innumerable devices for communicating messages to one another, from a multitude of written and spoken languages, gestures, signals and images to modern electronic apparatuses capable of delivering messages in ways and with speed that were unimaginable in the past.

As disclosed and claimed herein below, we have invented a new and exciting apparatus and method for communicating messages.

### SUMMARY

The present invention is directed to a throwable electronic recording device that has an impact-activated playback function for playing recorded messages. In operation, a user records a message with the recording device. After recording the message, the user puts the recording device in motion by, for example, throwing or dropping the device. Upon being caught by another person or impacting something, the device plays back the recorded message automatically. The message carried by the device can be any suitable type of recordable content, including audio content such as voice, music, noise or any other sound, and/or visual content such as graphics, images, lighting displays, video or the like.

In accordance with an exemplary embodiment of the present invention, the device is a throwable object having a body that can be, for example, a ball, flying disc (Frisbee®) or any other shape that is adapted to be thrown, tossed or otherwise put into motion and passed between a starting point of travel and an ending point. The object also includes a record/playback circuit, an input (e.g., a microphone) and an output (e.g., a speaker) operatively coupled to the record/playback circuit, and a record switch permitting a user to selectively cause the record/playback circuit to record a message received by the input. An impact switch included in the object causes the record/playback circuit to automatically playback the recorded message on the output in response to an impact to the throwable object. The message can include audio content, visual content or audio-visual content.

Other embodiments, features, aspects, advantages and methods of the invention will be or will become apparent to one with skill in the art upon examination of the following drawings and detailed description. It is intended that all such additional embodiments, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a perspective view of a throwable object in accordance with a first exemplary embodiment of the invention.

FIG. 2 is a perspective view of a throwable object in accordance with a second exemplary embodiment of the invention.

FIG. 3 is an exploded view of the throwable object shown in FIG. 1.

FIG. 4 is a schematic diagram showing details of the audio record/playback circuit shown in FIG. 3.

FIG. 5 is an exploded view of an integrated electronics module for housing the messaging circuitry.

FIG. 6 is a cross-sectional view of throwable object containing the integrated electronics module of FIG. 5, in accordance with a third exemplary embodiment of the invention.

FIG. 7 is a partial exploded view of the throwable object shown in FIG. 2.

### DETAILED DESCRIPTION

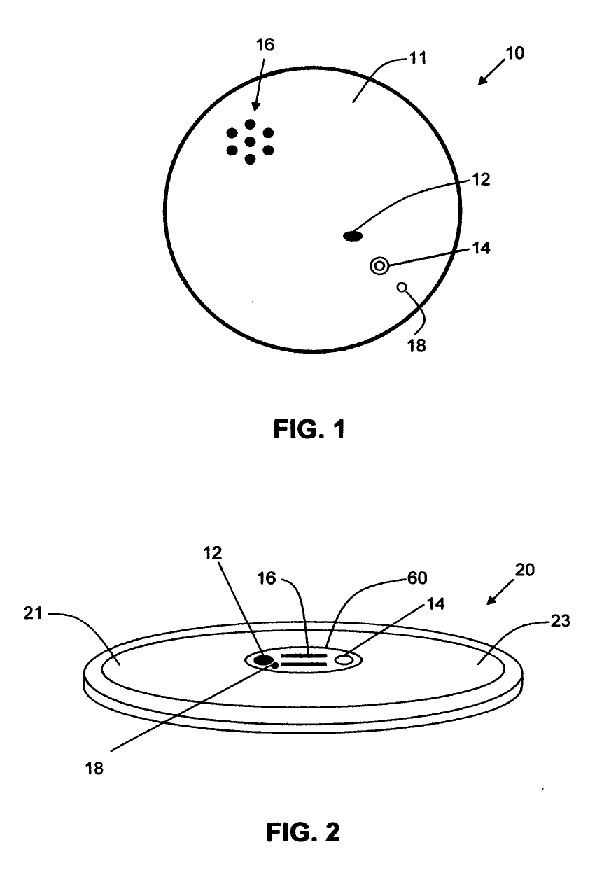

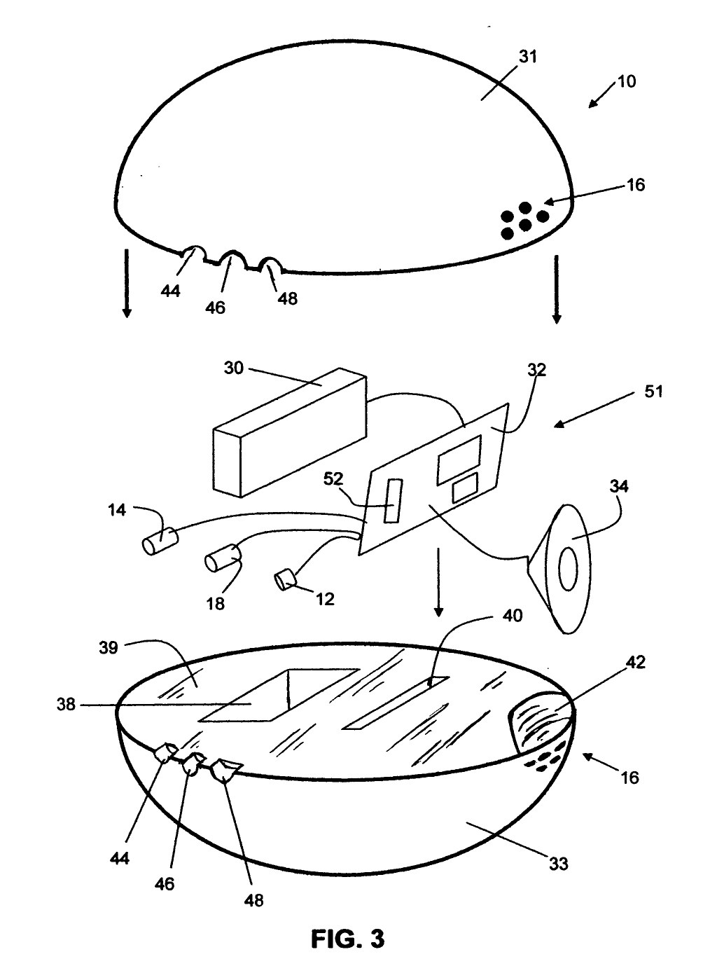

Turning now to the drawings, and in particular to FIG. 1, there is shown a perspective view of a throwable object 10 in accordance with a first exemplary embodiment of the invention. In this example, the throwable object 10 is a ball 11 having a record button 12, a microphone 14, an optional visual record indicator 18, and one or more speaker holes 16 located on its surface. Contained within the ball 11 is messaging circuitry, such as audio record/playback circuitry 51 (see FIG. 3).

In operation, a user records a message with the ball 11 by depressing the record button 12 and speaking into the microphone 14. After recording the message, the user throws or drops the ball 11. Upon being caught by another person or hitting something, the ball 11 plays back the recorded message automatically. With impact-activated playback, the recipient simply catches the ball 11 to hear the message. The record/playback circuitry has a message storage device that repeatedly allows a new message to be recorded over the stored message. Thus, the ball 11 can carry a different message each time it is thrown, particularly when it is thrown between different users. This unique messaging device provides a new and exciting twist on the game of playing catch: one that allows almost endless opportunities for creating amusing situations.

The ball 11 acts as a body for the throwable object 10, protecting the electronic components and defining the exterior shape of the throwable object 10. The ball 11 is adapted to be thrown about and to sustain repeated physical impacts without damage to the ball 11 itself or its internal components. The ball can be made of any suitable material or combination of materials, and is preferably made of a foam material, such as that used in a conventional Nerf® ball. The ball 11 can be substantially hollow or substantially solid, and can have any suitable configuration or number of internal structures, as well as any desirable surface texture, so long as the ball 11 adequately protects the record/playback components during use. In addition, the ball 11 can have any suitable shape, and is not limited to the spherical shape shown in FIG. 1.

The record button 12 is located on the exterior of the ball 11 so that it can be easily operated by the user. Preferably, the record button 12 is slightly recessed on the ball's exterior surface so that it is not inadvertently depressed (causing a false record) when the ball 11 is caught or hits something after being thrown. The record button 12 may be any suitable switch for operating the record feature, and is preferably a momentary-contact push button switch buried just under the ball's exterior surface. The switch is integrally located on the body so that a user can selectively cause the record/playback circuit 51 to record sound received by the microphone 14.

As an alternative to the push-button switch, the record button 12 can be implemented as a voice-activated switch that activates the record function upon detecting audio energy at the microphone 14 above a threshold value.

The microphone 14 is located along the ball's exterior surface so that it can better receive sound. The microphone 14 can be slightly recessed, or alternatively, it can be buried under the exterior surface of the ball 11 with a hole passing from the ball's surface to the microphone 14 for allowing sound to reach the microphone 14. The microphone 14 can be any suitable type of microphone and is preferably an electret microphone.

The visual record indicator 18 is any means for visually indicating to a user that the ball 11 is currently recording a message. Preferably, the visual record indicator 18 is a light emitting diode (LED) mounted on or near the ball's surface. The LED lights up when the record button 12 is depressed. The visual record indicator 18 is an optional feature of the throwable object 10.

The speaker holes 16 are formed along the exterior of the ball 11 to allow sound to pass from a playback speaker 34 (see FIG. 3) embedded within the ball 11. The holes 16 can be any suitable shape or number. As an alternative to burying the speaker 34 in the ball 11 and using the ball's exterior layer or other means to protect the speaker face, the speaker face can be exposed.

In an alternative arrangement, the microphone 14 and the speaker 34 are combined into a single audio transducer device that provides both microphone and speaker functions. Also, more than one speaker can be included in the object.

FIG. 2 is a perspective view of a throwable object 20 in accordance with a second exemplary embodiment of the invention. In this example, the throwable object 20 is a flying disc 21 having a record button 12, a microphone 14, a visual record indicator 18, and one or more speaker holes 16 located on its upper surface. Contained within the flying disc 21 is messaging circuitry, such as audio record/playback circuitry 51.

The flying disc 21 acts as a body carrying the messaging circuitry. The disc 21 functions in a manner similar to that described above in connection with the ball 11 of FIG. 1. The flying disc 21 can be any suitable size and can be made of any suitable material and construction, and is preferably made of injection molded plastic.

FIG. 3 is an exploded view of the throwable object 10 shown in FIG. 1. The ball 11 includes two mated halves 31,33 and audio record/playback circuitry 51. Each half 31,33 is made of an open cell foam, such as polyurethane.

The audio record/playback circuitry 51 includes an impact switch 52 connected to an audio record/playback circuit 32. The audio record/playback circuit 32 is wired to a power supply 30 (such as one or more batteries), a speaker 34, the record button 12, microphone 14 and visual record indicator 18.

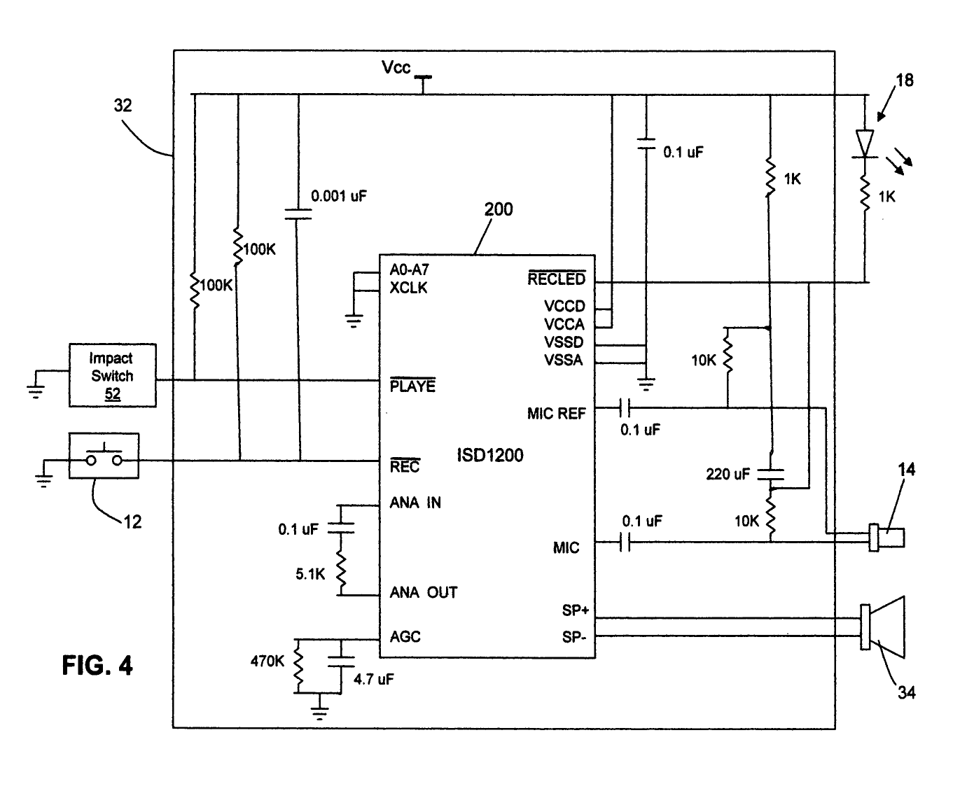

The audio record/playback circuit 32 can be any suitable electronic device for recording and playing back audio, but it is preferably based on a commercially-available audio recorder/playback integrated circuit (IC), such as the one illustrated in FIG. 4. The circuit 32 includes a memory for storing one or more audio messages. Preferably, the circuit 32 is capable of recording and storing a single message that is erased and recorded over each time the object 10 is used to record a new message. However, in an alternative configuration, the circuit 32 can record, store and playback plural recorded messages. In this configuration, the record/playback circuitry 51 includes additional user interfaces (e.g., buttons) or other means for selecting messages to record, playback and/or delete. The maximum length and number of messages is a matter of design choice.

The messaging circuitry can be configured to insert a slight playback delay at the beginning of each recorded message. The playback delay is a very useful feature because it allows the sound of the object's impact to pass before the recorded message plays back. It also allows a recipient to focus his/her attention on the message, rather than the act of catching the object. For example, when playing catch, a message recipient first concentrates on catching the object. Slightly delaying the message allows the recipient to recover his/her attention before hearing the message. Thus, this delay improves the clarity of the delivered message. The length of the delay can be any suitable period of time, such as a delay period between 0.1-0.5 seconds.

Using a voice record/playback integrated circuit (IC), such as the one shown in FIG. 4, the playback delay can be a period of silence stored in digital memory at the beginning of each recorded and stored message. The voice record/playback IC is programmed or otherwise configured to store digital values representing silence in the appropriate memory spaces.

To increase battery life, the record/playback circuitry 51 can be configured to enter a low-power standby state when not in use.

The impact switch 52 can be any suitable impact-activated electrical switch for triggering the playback function of the circuit 32. The impact switch 52 causes the record/playback circuit 32 to playback the recorded sound on the speaker 34 in response to an impact against the throwable object 10. Preferably, the switch 52 is a momentary contact switch having a coil spring conductor mounted in close proximity to a fixed conductor. Using this type of switch, when the object 10 receives an impact, the coil spring moves, contacting the fixed conductor to momentarily complete the circuit and trigger the playback function.

The sensitivity of the impact switch 52 can be selected so that it properly triggers the playback function of the record/playback circuit 32 during the anticipated normal use of the object 10, while minimizing false playback triggering. For instance, the sensitivity of the switch 52 can be set so that the record/playback circuitry 51 differentiates between when the throwable object 10 is thrown by a user and when the throwable object 10 is caught or hits something. Generally, the acceleration force on the object 10 when it is being thrown or otherwise released by a message sending user is less than the deceleration force on the object 10 when it impacts the intended message recipient. Properly setting the sensitivity of the switch 52 is important so that the recorded messages are played back when expected, and not prematurely.

Using an impact switch having a coil spring conductor as described above, the sensitivity of the switch 52 can be varied by changing the spring coefficient of the spring conductor and/or changing its physical location relative to the fixed conductor.

Each half 31,33 of the ball 11 has corresponding internal cavities 38,40 formed therein for receiving respective components 30,32 of the audio record/playback circuitry 51. One or more corresponding cavities 42,44,46,48 are formed in the halves 31,33 at or near the exterior surface of the ball 11 for receiving the speaker 42, microphone 44, visual indicator 18, and record button 12, respectively. The cavities 38,40,42,44,46,48 are shaped and sized to frictionally receive their respective components so as to secure them in place. Additionally or alternatively, a suitable adhesive can be used to secure the circuitry components in their cavities.

Wire tracks (not shown) connecting the cavities 38,40,42,44,46,48 can be formed as grooves on one or both of the interior faces 39 of the halves 31,33. The wire tracks receive the wires connecting the electrical components 12,14,18,30,34 to the audio record/playback circuit 32.

To assemble the object 10, the audio record/playback circuitry 51 is first placed into the cavities of one of the halves 31,33. The two halves 31,33 are then mated together and secured using an adhesive or any other suitable means, such as Velcro strips located on the faces 39. Using a non-permanent fastener such as Velcro, rather than an adhesive, allows the two halves 31,33 to be separated so that the batteries 30 can be conveniently replaced by a user.

FIG. 4 is a schematic diagram showing a specific exemplary implementation of the audio record/playback circuit 32 shown in FIG. 3. This implementation of the circuit 32 includes a Chipcorder® voice record/playback IC, part no. ISD1200 available from Winbond Electronics Corporation of Taiwan, connected to appropriate passive electrical components (resistors and capacitors).

An optional capacitor (not shown) can be connected in parallel with the impact switch 12 for conditioning the output signal of the impact switch.

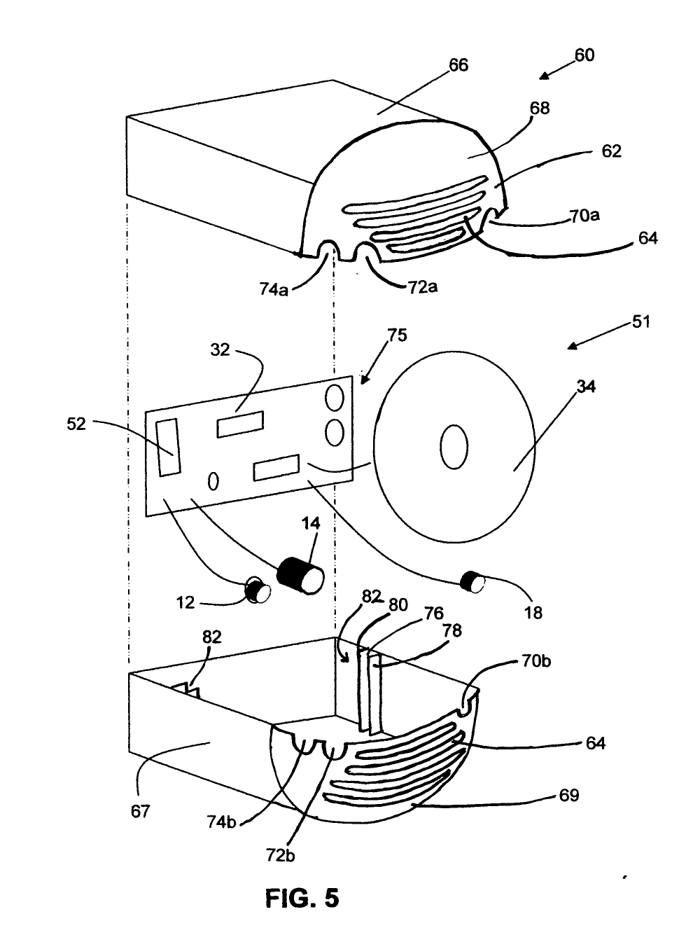

FIG. 5 is an exploded view of an integrated electronics module 60 for housing the audio record/playback circuitry 51. The substantially rectilinear module 60 secures and protects the circuitry 51 in a universal housing 62 having a standardized form factor so that the circuitry 51 can be readily integrated into throwable objects having different sizes and shapes.

The housing 62 includes a substantially hollow upper portion 66 mated to a substantially hollow lower portion 67.

The upper and lower portions 66,67 include, respectively, front convex portions 68,69 having a speaker grille 64 formed therein. The speaker 34 is mounted inside the housing 62 behind the front convex portions 68,69. The upper front convex portion 68 and the lower front convex portion 69 have corresponding openings 70a-b respectively formed therein for receiving the record visual indicator 18, corresponding openings 72a-b respectively formed therein for receiving the microphone 14, and corresponding openings 74a-b respectively formed therein for receiving the record button 12.

Behind the speaker mounts along opposing interior side walls of the housing portions 66,67 are mounts 82 for securing the audio record/playback circuit 32. Each of the mounts 82 include two substantially parallel vertical walls 78,80 extending away from respective opposing interior side walls. The parallel walls 78,80 form vertical slots 76 for receiving edges of the circuit board of the record/playback circuit 32.

To assemble the module 60, the audio record/playback circuitry 51 is first placed into the mounts 82,70b,72b,74b of the lower portion 67. The two portions 66,67 are then mated together and secured using an adhesive or any other suitable fastening means, such as screws or the like.

The housing 60 is preferably made of injection molded plastic.

The circuitry 51 of FIG. 5 illustrates the use of coin cell batteries 75, which are smaller and lighter than conventional batteries.

The housing 62 illustrated in FIG. 5 is exemplary only. The housing 62 can have any suitable shape, size, structure and configuration and be within the scope of the claimed invention.

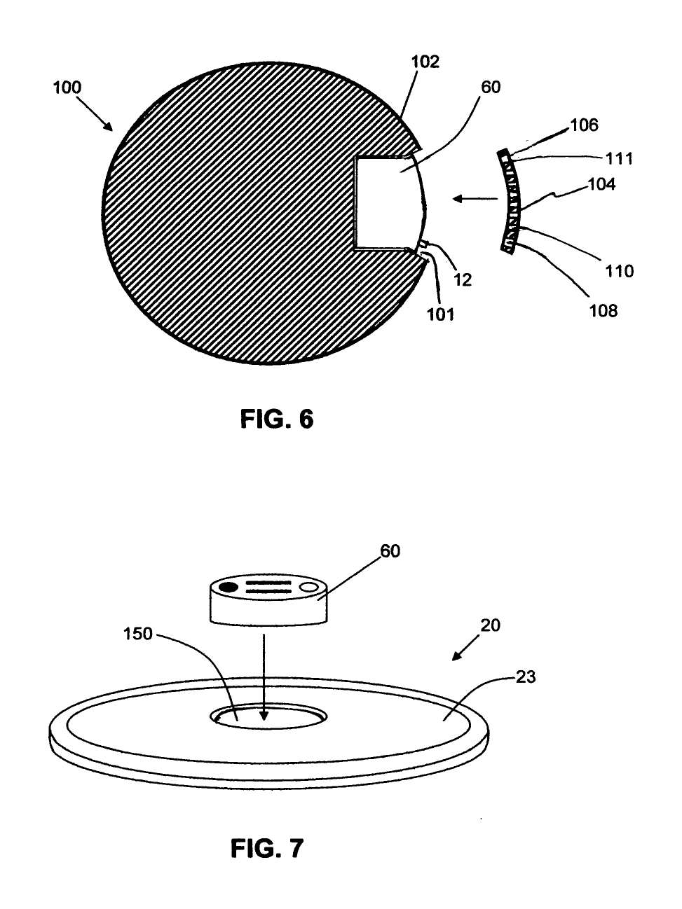

FIG. 6 is a partial cross-sectional view of an exemplary throwable object 100 containing the integrated electronics module 60 of FIG. 5, in accordance with a third embodiment of the invention. The object 100 has a substantially solid spherical body 102 having an open cavity 101 formed therein for receiving the electronics module 60. The open cavity 101 is shaped and sized so that the module 60 fits snuggly therein. The module 60 is secured in cavity 101 using a suitable adhesive. The body 102 may be made of any suitable material, and it is preferably made of an open cell foam, such as polyurethane.

The radius of curvature of the convex front portions 68,69 of the housing 60 is in proportion to that of the body 102 so as not to distort the body's spherical shape.

A cover 104 is attached over the module 60 using an adhesive or other suitable attaching means to generally conceal the module 60. The cover 104 is preferably made of the same material as the body 102. The cover has one or more speaker holes 110 formed therein, as well as a microphone hole 106, record button hole 108 and record visual indicator hole 111.

FIG. 7 is a partial exploded view of the throwable object 20 shown in FIG. 2. The flying disc 21 includes a disc portion 23 having a center hole or compartment 150 formed therein for receiving the electronics module 60. The module 60 can be secured into the center hole 150 using an adhesive or any other suitable fastening means.

For a throwable object that carries visual messages or audio-visual messages, video record/playback circuitry can be embedded in the object in a manner similar to that described above for audio only record/playback messaging. For video, a commercially-available digital or analog video record/playback circuit (preferably digital) can be securely mounted in the body of the object so that it is not damaged during use of the object. A user record interface is mounted in the body so that it is user accessible for the body's exterior. The record interface includes a miniature video camera, microphone (for audio-visual versions of the throwable object), recorder controls and the like. A playback output interface is mounted in or on the body so that it is visible from outside the body. The output interface includes a video display, such as a liquid crystal display (LCD) unit or a video projector, and a speaker for audio-visual messaging. The impact switch included in the throwable object triggers the playback function.

In an alternative version of the throwable object, a manually-operated playback switch (not shown) is substituted for the impact switch 52 in the above embodiments. The manually-operated playback switch is located at or near the surface of the object, in a manner similar to that for the record button 12, so that a user can manually activate the message playback function of the circuitry 51. The manual playback switch can be any suitable switching device, such as a momentary-contact push-button switch or the like. Although this version does not provide the automatic playback function, it may be desirable in some circumstances.

While various embodiments of the invention have been described, it will be apparent to those of ordinary skill in the art that more embodiments and implementations, other than those specifically described above, are possible that are within the scope of this invention. Further, the foregoing summary, detailed description and drawings are considered as illustrative only of the principles of the invention and are not intended to limit the scope of the invention. Since other modifications and changes may be or become apparent to those skilled in the art, the invention is thus not limited the exact embodiments shown and described above, and accordingly, all suitable modifications and equivalents are deemed to fall within the scope of the invention, as it is defined by the claims below.

What we claimed is:

1. A throwable object, comprising:
a body adapted to be thrown and defining the exterior shape of the throwable object;
a record/playback circuit contained within the body;
input means secured to the body and operatively coupled to the record/playback circuit;
output means secured to the body and operatively coupled to the record/playback circuit;
a record switch, secured to the body and user-operable from the exterior of the body, for allowing a user to selectively cause the record/playback circuit to record a message received by the input means; and
an impact switch for causing the record/playback circuit to playback the recorded message on the output means in response to an impact against the throwable object.

2. The throwable object of claim 1, wherein the message includes content selected from the group consisting of audio content, visual content and a combination of the foregoing.

3. The throwable object of claim 1, further comprising:
a housing secured within the body for holding at least the record/playback circuit.

4. The throwable object of claim 1, further comprising:
means for delaying playback of the recorded message for a predetermined time period.

5. A throwable object, comprising:
a body adapted to be thrown and defining the exterior shape of the throwable object;
a record/playback circuit contained within the body;
a microphone secured to the body and operatively coupled to the record/playback circuit;
a speaker secured to the body and operatively coupled to the record/playback circuit;
a record switch, secured to the body and operable from the exterior of the body, for allowing a user to selectively cause the record/playback circuit to record sound received by the microphone; and
an impact switch for causing the record/playback circuit to playback the recorded sound on the speaker in response to an impact against the throwable object.

6. The throwable object of claim 5, wherein the body is a flying disc.

7. The throwable object of claim 5, wherein the body is a ball.

8. The throwable object of claim 7, wherein the ball is a foam ball.

9. The throwable object of claim 5, wherein the body has one or more internal cavities for containing the record/playback circuit, the microphone, the speaker, the record switch and the impact switch.

10. The throwable object of claim 5, wherein the impact switch has a predetermined sensitivity that differentiates between when the throwable object is thrown and when the throwable object is caught.

11. The throwable object of claim 5, further comprising a capacitor connected in parallel with the impact switch for conditioning the output signal of the impact switch.

12. The throwable object of claim 5, wherein the record switch is selected from the group consisting of a push-button switch and a voice-activated switch.

13. The throwable object of claim 5, further comprising at least one battery contained in the body.

14. The throwable object of claim 5, wherein the microphone and the speaker are combined into a single audio transducer device that provides both microphone and speaker functions.

15. The throwable object of claim 5, wherein the record/playback circuit enters a low-power standby state when not in use.

16. A throwable object for playing a game of catch, comprising:
a foam body defining the exterior shape of the throwable object and having one or more interior cavities formed therein;
a record/playback circuit contained within one of the cavities;
a microphone mounted in one of the cavities at or near the surface of the foam body and operatively coupled to the record/playback circuit;
a speaker mounted in one of the cavities at or near the surface of the foam body and operatively coupled to the record/playback circuit;
a record switch located in one of the cavities at or near the surface of the foam body so that a user can selectively cause the record/playback circuit to record sound received by the microphone; and
an impact switch for causing the record/playback circuit to playback the recorded sound on the speaker in response to the throwable object being caught.

17. The throwable object of claim 16, further comprising a housing formed to fit into the cavities of the foam body, for housing the record/playback circuit.

18. The throwable object of claim 17, wherein the housing houses components selected from the group consisting of the microphone, speaker, record switch, impact switch and any combination of the foregoing.

19. The throwable object of claim 16, further comprising a capacitor connected in parallel with the impact switch for conditioning the output signal.

20. The throwable object of claim 16, wherein the record switch is selected from the group consisting of a push-button switch and a voice-activated switch.

21. The throwable object of claim 16, further comprising at least one battery contained in the body.

22. The throwable object of claim 16, wherein the microphone and the speaker are combined into a single audio transducer device that provides both microphone and speaker functions.

23. The throwable object of claim 16, wherein the record/playback circuit enters a low-power standby state when not in use.

24. A method of operating an object adapted to be thrown and capable of recording and playing back a message, comprising:
actuating a record switch operable from an exterior surface of the throwable object to record the message, wherein the message is stored in the throwable object; and
throwing the throwable object, wherein the recorded message is automatically played back upon impact of the throwable object.
